(19) United States
(12) Patent Application Publication
(10) Pub. No.: US 2014/0278931 A1
(43) Pub. Date: Sep. 18, 2014

(54) TIME-VARYING MODELING FOR MARKETING DRIVERS

(71) Applicant: ACCENTURE GLOBAL SERVICES LIMITED, Dublin (IE)

(72) Inventor: Dimitrios Bagkavos, Athens (GR)

(73) Assignee: Accenture Global Services Limited, Dublin (IE)

(21) Appl. No.: 13/838,862

(22) Filed: Mar. 15, 2013

(51) Int. Cl. G06Q 30/02

(52) U.S. Cl. CPC G06Q 30/0246
USPC 705/14.45

(57) ABSTRACT

A marketing modeling system may include a modeling engine to determine a time-varying marketing driver model to estimate marketing driver contributions to sales for marketing drivers, and determine a time-varying parameter and multiply the time varying parameter by an independent time-varying variable in the time-varying marketing driver model. A driver contribution estimation module in the system may apply the time-varying marketing driver model to consecutive fine-grained time periods to determine estimated contributions to sales for each fine-grained time period and for each marketing driver.

### BACKGROUND

Measuring the impact of marketing on sales has long been seen as an essential planning tool for marketers. Understanding the return on marketing investment (MROI) of one promotional activity over another, in terms of sales generated, can help justify the costs of a marketing campaign. Intuitively, marketers generally estimate the effectiveness of each marketing activity in driving sales. However, given the many different factors that can effect sales, it is difficult to determine an accurate picture of how different marketing activities impact sales especially for short time periods.

### BRIEF DESCRIPTION OF DRAWINGS

The embodiments are described in detail in the following description with reference to examples shown in the following figures.

FIG. 1 illustrates a marketing modeling system.

FIG. 2 illustrates a visual representation of marketing driver contributions.

FIG. 3 illustrates a flow chart of a method for determining marketing driver contributions.

FIG. 4 illustrates an example of a computer system that may be used for the method and system described herein.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

According to an embodiment, a marketing modeling system determines a time-varying marketing driver model that may be used to estimate the impact of marketing drivers for multiple different marketing channels on sales of a product, which may be a good or service. A marketing driver may include activities for a particular marketing channel, such as activities for TV advertising, print media advertising, online advertising, direct mail/email advertising, etc.

The time-varying marketing driver model can provide an accurate estimate of each marketing driver's contribution to sales for a fine-grained time period. The fine-grained time period may be any time period ranging from daily to monthly, inclusive, such as daily, weekly, bi-weekly, or monthly. Weekly is used in many of the examples described below. However, the time-varying marketing driver model may be used to estimate marketing driver contributions to sales for any time period as long as there is historical sales data for the time period.

Budget allocations for the marketing drivers can be determined based on the estimated driver contributions. Also, the system can provide an easy to understand graphical display of driver contributions to help determine the budget allocations and for making other marketing decisions including: whether money should be spent on the same drivers in the coming year; what is the most effective mix of drivers; when should the promotional activities begin for each driver and the duration the activities should be performed.

FIG. 1 illustrates an example of the marketing modeling system 100 according to an embodiment. The system 100 may include a modeling engine 101, a driver contribution estimation module 102, a calibration module 103, a visualization module 104, an analytics module 105 and a user interface 106. The system 100 may comprise hardware and/or machine readable instructions executed by at least one processor. The system 100 may include a data repository 110 which can store historic sales data 113 and any data used by the system 100. The data repository 110 may comprise a database or another type of data storage system. The data repository 110 may be part of the system 100 or provided as a separate storage system which may be hosted on a database server that is connected to the system 100 to exchange data, such as via a network.

The modeling engine 101 determines a time-varying marketing driver model 111 which may be used to estimate marketing driver contributions to sales for a multiple marketing drivers and for fine-grained time periods. The time-varying marketing driver model 111 includes a time-varying parameter and an independent time-varying variable. The independent time-varying variable (e.g., X) is associated with a marketing driver's contribution to sales for a given time period and the time-varying parameter (e.g., β) is associated with an effectiveness of the marketing driver to contribute to the sales. The modeling engine 101 can adjust the time-varying marketing driver model 111 for example by determining the time-varying parameter β for the time period. The time-varying marketing driver model 111 is described in further detail below. The time-varying marketing driver model 111 and the time-varying parameter β can be stored in the data repository 110. The time-varying parameter β can be determined and stored for each time period. For example, the time-varying parameter β may be determined for each week in a year and stored in the data repository 110. Also, the time-varying marketing driver model 111 and parameters and variables 112 for the model 111 are shown as stored in the data repository 110. The historic sales data 113 is also shown as stored in the data repository 110.

The driver contribution estimation module 102 can apply the time-varying marketing driver model 111 to determine the estimated contributions 120 to sales by the marketing drivers. The estimated contributions 120 may be shown in the user interface 106, which may be a graphical user interface. The visualization module 104 may generate a display in the user interface 106 of the estimated marketing driver contributions to sales over consecutive fine-grained time periods. The estimated marketing driver contributions for each time period are based on the time-varying parameter β representing effectiveness of the marketing driver to contribute to the sales for that time period.

The calibration module 103 may determine constraints 114 for the time-varying parameter β and apply the constraints to the time-varying parameter β to calibrate the time-varying parameter β. A user may provide the constraints 114 and the constraints may be stored in the data repository 110. For example, assume the marketing driver is TV advertising. If the time-varying parameter β is negative, it means that the more they advertise, the more sales they lose, which is incorrect and would be unacceptable to a user of the system 100. Accordingly, a constraint may be stored that indicates if β is negative for TV advertising, then use a default value for β that is positive. Other constraints may be used such as specifying a certain range for each marketing driver's β.

The analytics module 105 performs analytics based on the estimated marketing driver contributions to sales. The analytics module 105 may determine budget allocations for the marketing drivers based on the estimated driver contributions, the most effective mix of marketing drivers to implement and when the activities for the marketing drivers should begin and their duration. For example, the analytics module 105 may analyze marketing driver contributions for a time period, such as a quarter, and determine the fine-grained marketing driver contributions, such as weekly, within the quarter. The analytics module 105 may determine that three specific marketing drivers had the majority of the contribution of the marketing drivers for sales (e.g., 75%) for three consecutive weeks. The analytics module 105 may determine that 75% of the marketing budget for the three consecutive weeks should be allocated to those marketing drivers and that a portion of the 75% may be allocated to each of these marketing drivers depending on their contributions. The analytics module 105 may determine when the activities for the marketing drivers should begin, such as 1 week prior to the three consecutive weeks and their duration, such as 2.5 weeks). This information, which is shown as marketing driver analytics output 121, may be displayed via the user interface 106 and may be stored in the data repository 110.

The time-varying marketing driver model 111 is now described. Equation 1 represents an example of the time-varying marketing driver model 111.

Yₜ=μₜ+γₜ+vₜ+ΣᵢβᵢXₜ+εₜ Equation 1:

Yₜ is the total sales for a product for a time period t. The total sales for example is a monetary value. The time period t may be a historic time period, such as week 13 in the previous calendar year, and the total sales may be for that historic time period. The total sales may be determined from the historic sales data 113 stored in the data repository 110.

μₜ+γₜ+vₜ represent a baseline contribution to Y. For example, the baseline contribution, also referred to as the baseline, may include a contribution to the total sales Yₜ that may not be contributed to by the marketing drivers, e.g., independent from the marketing drivers. The baseline may represent loyal sales. For example, μₜ represents a trend parameter, γₜ represents a seasonal parameter, and vₜ represents an autoregressive parameter that may represent random economic factors or other factors. The summed values for these parameters is the baseline. In one example, the baseline value may be determined based on a historic baseline for the same time period. The baseline may vary for each time period.

i represents the marketing drivers from 1 to i.

ΣᵢβᵢXₜ is referred to as the first term. β is effectiveness of each marketing driver and X is the amount spent on the marketing driver for the time period. The amount spent for example is the amount spent on the activities for the marketing driver which may include the cost of advertising on the marketing channel associated with the marketing driver. βᵢXₜ represents the amount of sales achieved by investing in the marketing driver i for the time period t.

εₜ is an error parameter. εₜ may represent an error associated with a difference between estimated sales and actual sales.

All the values of the time-varying marketing driver model 111 are known except β, so equation 1 can be solved to determine the value of β. A Kalman filter may be used to solve the equation. The Kalman filter is a known function that uses a series of measurements observed over time, containing noise (random variations) and other inaccuracies, and produces estimates of unknown variables that tend to be more precise than those based on a single measurement alone. The Kalman filter operates recursively on streams of input data, such as the historic sales data and data for other variables to produce a statistically optimal estimate, such as the β's. The Kalman filter is widely applied in time series analysis.

β allows the user to determine how effective their investment was in contributing to the total sales for the time period. β is a variable that varies from time-period-to-time-period. β is not a predetermined value used for all time periods. However, a user can select which marketing drivers to vary β over time and which marketing drivers to stay constant. Statistical analysis and business constraints may be used to determine whether β is accurate by the calibration module 103.

As indicated above, all the values of the time-varying marketing driver model 111 are known except β, so equation 1 can be solved to determine the value of β.

FIG. 2 shows an example of a visual representation 200 of marketing driver contributions that may be generated by the visualization module 104 in the user interface 106. The visual representation 200 shows the contribution of marketing drivers comprising circulars, which may include a type of print advertisement, and other promotions. The contribution of the baseline to the total sales is also shown. The contributions are shown on a week-by-week basis over a two year time period. The dashed line represents the total sales Yₜ. The baseline graph shows the contribution of the total sales attributed to the baseline. The circulars and the other promotions graphs shows the contribution of the total sales attributed to the circulars marketing driver and the other promotions marketing driver respectively. The circulars and the other promotions graphs represents βᵢXₜ for each marketing driver, which is the incremental sales attributed to the marketing driver. Table 1 shows some of the data plotted in FIG. 2. The wdate column represents the wee-by-week dates. The baseline, circular and other promotions columns represent the contributions of each to the total sales. The fitted column represents the sum of circulars and other promotions, and the total sales values are shown which may be determined from historic sales data.

TABLE 1

| wdate | Baseline | Circular | Other promotion | fitted | Total Sales |
|---|---|---|---|---|---|
| Jan. 31, 2010 | 76246858.3 | 30259086.3 | 2759492.1 | 109265436.7 | 108526687.5 |
| Feb. 7, 2010 | 76399743.3 | 26383020.5 | 3168379.0 | 105951142.7 | 128790194.7 |
| Feb. 14, 2010 | 76499906.9 | 4901860.0 | 6938974.0 | 88340740.9 | 95120655.2 |
| Feb. 21, 2010 | 76489197.2 | 15242889.7 | 6062369.0 | 97794455.9 | 92082928.2 |
| Feb. 28, 2010 | 76644842.6 | 5921725.6 | 4254743.4 | 86821311.6 | 96362245.3 |
| Mar. 7, 2010 | 76679375.2 | 7829216.3 | 5276433.4 | 89785025.0 | 98253108.1 |
| Mar. 14, 2010 | 76583396.0 | 24065426.6 | 5888695.3 | 106537517.9 | 105437088.8 |
| Mar. 21, 2010 | 76553053.9 | 10356772.4 | 6723683.5 | 93633509.8 | 111370997.2 |
| Mar. 28, 2010 | 76128577.1 | 18494561.8 | 6622088.5 | 101245227.3 | 169082916.2 |
| Apr. 4, 2010 | 75401486.4 | 4122051.0 | 5972499.1 | 85496036.5 | 74987703.4 |
| Apr. 11, 2010 | 74936011.6 | 5732236.3 | 4805199.2 | 85473447.1 | 87877348.0 |
| Apr. 18, 2010 | 74469188.8 | 14365770.0 | 3835513.8 | 92670472.5 | 91732775.6 |
| Apr. 25, 2010 | 74076643.0 | 13701232.8 | 4171922.3 | 91949798.1 | 88261540.4 |
| May 2, 2010 | 73839616.6 | 3537777.7 | 5162508.3 | 82539902.5 | 90852003.0 |
| May 9, 2010 | 73487562.6 | 6176316.1 | 7303433.3 | 86967312.0 | 87008531.2 |
| May 16, 2010 | 73155772.7 | 6610712.8 | 7965026.2 | 87731511.7 | 89807670.0 |
| May 23, 2010 | 72797403.1 | 11979024.2 | 7489880.7 | 92266308.0 | 91704314.7 |
| May 30, 2010 | 72543098.0 | 7777071.7 | 8954624.1 | 89274793.8 | 87518528.3 |
| Jun. 6, 2010 | 72390054.0 | 12426354.2 | 8291782.4 | 93108190.5 | 88724572.7 |
| Jun. 13, 2010 | 72350887.2 | 4955828.8 | 7618821.8 | 84925537.8 | 90485233.0 |
| Jun. 20, 2010 | 72225934.7 | 4430151.2 | 10103542.5 | 86759628.4 | 87034458.9 |
| Jun. 27, 2010 | 72107356.7 | 16386365.3 | 11344267.7 | 99837989.6 | 94425918.0 |
| Jul. 4, 2010 | 72058997.6 | 17039880.5 | 10296522.7 | 99395400.8 | 87156304.7 |
| Jul. 11, 2010 | 72274461.7 | 7373841.2 | 10590158.5 | 90238461.4 | 90305162.5 |
| Jul. 18, 2010 | 72540155.4 | 4636329.5 | 12673276.6 | 89849761.5 | 89640818.5 |
| Jul. 25, 2010 | 72827020.4 | 4438048.9 | 14675081.7 | 91940151.1 | 88966133.7 |
| Aug. 1, 2010 | 73099543.4 | 7317880.8 | 13323343.0 | 93740767.2 | 92906856.9 |

From table 1 and FIG. 2 it is shown that the contributions may not add up to the total sales for each week. That is because β is an estimation of the contribution and also because there may be other factors that contribute to sales. Other information may be determined from FIG. 2. For example on Jan. 31, 2010 and Jan. 1, 2011, the circulars had a much greater impact on sales than the other promotions, so for January 31^{st} and weeks surrounding January 31^{st}, the analytics module 105 may estimate that a larger contribution of the marketing budget should be applied to the circulars for those time periods. In one example, the budget allocation may be proportional to the contribution of each driver.

FIG. 3 illustrates an example of method 300 for estimating the contributions of marketing drivers to sales. The method 300 may be performed by the system 100 shown in FIG. 1 or other systems. At 301, the system 100 receives and stores the historic sales data 113. At 302, the modeling engine 101 determines the time-varying marketing driver model 111 to estimate marketing driver contributions to sales for multiple marketing drivers. For example, the known values for the parameters for the time-varying marketing driver model 111 represented by equation 1 are retrieved from the data repository 110. The known values for all the parameters may have been previously stored.

At 303, the modeling engine 101 adjusts the time-varying marketing driver model 111. The adjusting may include solving equation 1 to determine β. Then, the marketing driver effectiveness may be determined by βᵢXₜ which represents the amount of sales achieved by investing in the marketing driver i for the time period t. β may be determined for each marketing driver and for each time period.

At 304, β may be calibrated by the calibration module 103. Calibration may include evaluating β based on constraints, which may also include a statistical analysis. If β does not satisfy the constraints, which may include exceeding a predetermined threshold or statistical deviations, then β may be changed to a default value.

At 305, the driver contribution estimation module 102 determines contributions of the marketing drivers to sales based on the adjusted model for one or more fine-grained time periods. For example, βᵢXₜ represents the contribution of a marketing driver.

At 306, the analytics module determines analytics for the marketing drivers, which may include budget allocations, when to invest in certain marketing drivers and the duration for performing activities for the marketing drivers.

FIG. 4 shows a computer system 400 that may be used with the embodiments and examples described herein. The computer system 400 includes components that may be in a server or another computer system. The computer system 400 may execute, by one or more processors or other hardware processing circuits, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 400 includes at least one processor 402 that may implement or execute machine readable instructions performing some or all of the methods, functions and other processes described herein. Commands and data from the processor 402 are communicated over a communication bus 404. The computer system 400 also includes a main memory 406, such as a random access memory (RAM), where the machine readable instructions and data for the processor 402 may reside during runtime, and secondary data storage 408, which may be non-volatile and stores machine readable instructions and data. For example, machine readable instructions for the marketing modeling system 100 may reside in the memory 406 during runtime. The memory 406 and secondary data storage 408 are examples of computer readable mediums.

The computer system 400 may include an I/O device 410, such as a keyboard, a mouse, a display, etc. For example, the I/O device 410 includes a display to display drill down views and other information described herein. The computer system 400 may include a network interface 412 for connecting to a network. Other known electronic components may be added or substituted in the computer system 400. Also, the marketing modeling system 100 may be implemented in a distributed computing environment, such as a cloud system.

While the embodiments have been described with reference to examples, various modifications to the described embodiments may be made without departing from the scope of the claimed embodiments.

What is claimed is:

1. A marketing modeling system comprising:
a data repository to store historic sales data; and
a modeling engine, executed by a processor, to
determine a time-varying marketing driver model to estimate marketing driver contributions to sales for a plurality of marketing drivers, and
adjust the time-varying marketing driver model, wherein the adjusting includes determining a time-varying parameter (B) and multiplying the time-varying parameter by an independent time-varying variable (X) in the time-varying marketing driver model; and
a driver contribution estimation module to apply the adjusted time-varying marketing driver model to consecutive fine-grained time periods to determine an estimated contribution to sales for each fine-grained time period and for each of the plurality of marketing drivers based on the historic sales data.

2. The system of claim 1, comprising:
a calibration module to determine constraints for the time-varying parameter and apply the constraints to the time-varying parameter to calibrate the time-varying parameter.

3. The system of claim 1, wherein the adjusted time-varying marketing driver model comprises:
a baseline, a first term representing a variable summed over all the marketing drivers, wherein the first term includes the time-varying parameter multiplied by the independent time-varying variable, and the independent time-varying variable represents an amount spent for each marketing driver and the time-varying parameter represents an effectiveness of each driver for each fine-grained time period.

4. The system of claim 3, wherein the adjusted time-varying marketing driver model comprises:
Yₜ=μₜ+γₜ+vₜ+ΣᵢβᵢXₜ+εₜ
wherein Yₜ is historic sales for a product for the fine-grained time period t,
i represents the marketing drivers from 1 to i,
μₜ represents a trend parameter,
γₜ represents a seasonal parameter,
vₜ represents an autoregressive term, wherein μₜ+γₜ+vₜ is the baseline,
ΣᵢβᵢXₜ is the first term wherein β is the time-varying parameter and X is the independent time-varying variable, and
εₜ represents an error associated with a difference between estimated sales and actual sales.

5. The system of claim 1, comprising:
a visualization module to generate a display of the estimated marketing driver contributions for the consecutive fine-grained time periods in a graphical user interface.

6. The system of claim 1, comprising:
a budgeting analytics module to receive a user input of a marketing budget for the consecutive fine-grained time periods, and to determine an allocation of the marketing budget for the marketing drivers for the consecutive fine-grained time periods based on the estimated marketing driver contributions.

7. The system of claim 1, wherein each fine-grained time period comprises a time period between daily and monthly, inclusive.

8. A method for estimating contributions of marketing drivers to sales, the method comprising:
receiving historic sales data;
determining a time-varying marketing driver model to estimate marketing driver contributions to sales for a plurality of marketing drivers;
adjusting the time-varying marketing driver model, wherein the adjusting includes determining, by a processor, a time-varying parameter and multiplying the time-varying parameter by an independent time-varying variable in the time-varying marketing driver model; and
determining contributions of the plurality of marketing drivers on sales based on the adjusted model for a fine-grained time period and the historic sales data.

9. The method of claim 8, wherein the adjusted time-varying marketing driver model comprises:
a baseline, a first term representing a variable summed over all the marketing drivers, wherein the first term includes the time-varying parameter multiplied by the independent time-varying variable, and the independent time-varying variable represents an amount spent for each marketing driver and the time-varying parameter represents an effectiveness of each driver for each fine-grained time period.

10. The method of claim 9, wherein the adjusted time-varying marketing driver model comprises:
Yₜ=μₜ+γₜ+vₜ+ΣᵢβᵢXₜ+εₜ
wherein Yₜ is historic sales for a product for the fine-grained time period t,
i represents the marketing drivers from 1 to i,
μₜ represents a trend parameter,
γₜ represents a seasonal parameter,
vₜ represents an autoregressive term, wherein μₜ+γₜ+vₜ is the baseline,
ΣᵢβᵢXₜ is the first term wherein β is the time-varying parameter and X is the independent time-varying variable, and
εₜ represents an error associated with a difference between estimated sales and actual sales.

11. The method of claim 8, comprising:
determining constraints for the time-varying parameter; and
calibrating the time-varying parameter based on the constraints.

12. The method of claim 8, comprising:
determining estimated marketing driver contributions for consecutive fine-grained time periods based on applying the adjusted the time-varying marketing driver model to the historical sales data over the consecutive fine-grained time periods; and
generating a display of the estimated marketing driver contributions for the consecutive fine-grained time periods.

13. The method of claim 12, comprising:
receiving a user input of a marketing budget for the consecutive fine-grained time periods; and
determining an allocation of the marketing budget for the marketing drivers for the consecutive fine-grained time periods based on the estimated marketing driver contributions.

14. The method of claim 8, wherein the fine-grained time period comprises a time period between daily and monthly, inclusive.

15. A non-transitory computer readable medium including machine readable instructions that are executable by at least one processor to:
receive historic sales data;
determine a time-varying marketing driver model to estimate marketing driver contributions to sales for a plurality of marketing drivers;
adjust the time-varying marketing driver model, wherein the adjusting includes determining, by a processor, a time-varying parameter and multiplying the time-varying parameter by an independent time-varying variable in the time-varying marketing driver model; and
determine contributions of the plurality of marketing drivers on sales based on the adjusted model for a fine-grained time period and the historic sales data, wherein the fine-grained time period comprises a time period between daily and monthly, inclusive.

16. The non-transitory computer readable medium of claim 15, wherein the adjusted time-varying marketing driver model comprises:
a baseline, a first term representing a variable summed over all the marketing drivers, wherein the first term includes the time-varying parameter multiplied by the independent time-varying variable, and the independent time-varying variable represents an amount spent for each marketing driver and the time-varying parameter represents an effectiveness of each driver for each fine-grained time period.

17. The non-transitory computer readable medium of claim 16, wherein the adjusted time-varying marketing driver model comprises:
Yₜ=μₜ+γₜ+vₜ+ΣᵢβᵢXₜ+εₜ
wherein Yₜ is historic sales for a product for the fine-grained time period t,
i represents the marketing drivers from 1 to i,
μₜ represents a trend parameter,
γₜ represents a seasonal parameter,
vₜ represents an autoregressive term, wherein μₜ+γₜ+vₜ is the baseline,
ΣᵢβᵢXₜ is the first term wherein β is the time-varying parameter and X is the independent time-varying variable, and
εₜ represents an error associated with a difference between estimated sales and actual sales.

18. The non-transitory computer readable medium of claim 15, wherein the machine readable instructions are to:
determine constraints for the time-varying parameter; and
calibrate the time-varying parameter based on the constraints.

19. The non-transitory computer readable medium of claim 15, wherein the machine readable instructions are to:
determine estimated marketing driver contributions for consecutive fine-grained time periods based on applying the adjusted the time-varying marketing driver model to the historical sales data over the consecutive fine-grained time periods; and
generate a display of the estimated marketing driver contributions for the consecutive fine-grained time periods.

20. The non-transitory computer readable medium of claim 19, wherein the machine readable instructions are to:
receive a user input of a marketing budget for the consecutive fine-grained time periods; and
determine an allocation of the marketing budget for the marketing drivers for the consecutive fine-grained time periods based on the estimated marketing driver contributions.
